(19) United States
(12) Patent Application Publication
(10) Pub. No.: US 2018/0273821 A1
(43) Pub. Date: Sep. 27, 2018

(54) M-TOLUIC ACID CONTAINING CORROSION INHIBITOR FOR COOLANT FORMULATIONS

(71) Applicant: Cummin Filtration IP, Inc., Columbus, IN (US)

(72) Inventors: Doug Hudgens, Cookeville, TN (US); Lauren Lewis, Hendersonville, TN (US); Yu Sen Chen, Naperville, TN (US); Dakota Johnson, Cockeville, TN (US)

(73) Assignee: Cummin Filtration IP, Inc., Columbus, IN (US)

(21) Appl. No.: 15/781,938

(22) PCT Filed: Dec. 8, 2016
(86) PCT No.: PCT/US16/65562

§ 371 Date: Jun. 6, 2018

Related U.S. Application Data
(60) Provisional application No. 62/266,448, filed on Dec. 11, 2015.

(51) Int. Cl. C09K 5/10; C09K 5/20; C23F 11/12

(52) U.S. Cl. CPC C09K 5/10; C23F 11/124; C09K 5/20

(57) ABSTRACT

A corrosion inhibitor for a coolant formulation. The corrosion inhibitor includes m-toluic acid. The m-toluic acid may be present in an amount of 0.05-10 wt. % based on the total weight of the coolant formulation. The corrosion inhibitor may additionally include sebacic acid. The sebacic acid may be present in an amount of 0.05-10 wt. % based on the total weight of the coolant formulation.

### CROSS-REFERENCE TO RELATED APPLICATIONS

This application is related to and claims priority to U.S. Provisional Patent Application No. 62/266,448, entitled “M-TOLUIC CONTAINING CORROSION INHIBITOR FOR COOLANT FORMULATIONS,” by Hudgens et al., filed on Dec. 11, 2015, the contents of which are herein incorporated by reference in its entirety and for all purposes

### BACKGROUND

The present invention relates generally to the field of corrosion inhibitors for coolant formulations.

In an effort to reduce weight, internal combustion engines are now utilizing aluminum components in place of components that were previously cast iron. For this reason, there has been an effort to identify coolant additives which provide improved aluminum corrosion and/or cavitation protection. One such additive, 2-Ethylhexanoic acid, has been established as an effective aluminum corrosion inhibitor. However, this additive can be detrimental to silicone seals in a cooling system and has an undesirably high toxicity.

### SUMMARY

One embodiment relates to a corrosion inhibitor for a coolant formulation. The corrosion inhibitor includes m-toluic acid. The m-toluic acid may be present in an amount of 0.05-10.0 wt. % based on the total weight of the coolant formulation. The corrosion inhibitor may additionally include sebacic acid. The sebacic acid may be present in an amount of 0.05-10.0 wt. % based on the total weight of the coolant formulation.

A second embodiment relates to a method of increasing the corrosion resistance of a coolant formulation. The method includes mixing a coolant formulation with m-toluic acid. The method may additionally include mixing the coolant formulation with sebacic acid.

A further example embodiment relates to a coolant. The coolant may be, for example, used in the cooling system of an internal combustion engine. The coolant includes a base fluid and a corrosion inhibitor. The corrosion inhibitor comprises m-toluic acid. The m-toluic acid may be present in an amount of 0.05-10.0 wt. % based on the total weight of the coolant. The corrosion inhibitor may additionally include sebacic acid. The sebacic acid may be present in an amount of 0.05-10.0 wt. % based on the total weight of the coolant.

### BRIEF DESCRIPTION OF THE DRAWINGS

References are made to the accompanying drawings that form a part of this disclosure, and which illustrate the embodiments in which the systems and methods described in this specification can be practiced.

FIG. 1 is a molecular structure diagram for m-toluic acid.

FIG. 2 is a molecular structure diagram for sebacic acid.

FIG. 3 is a plot of aluminum sample weight loss as a function of time, when exposed to a variety of corrosion inhibitors.

### DETAILED DESCRIPTION

Embodiments described and depicted herein relate generally to a corrosion inhibitor for coolant compositions that is particularly effective at protecting aluminum in a cooling system and is compatible with silicone based elastomer materials. More specifically, the corrosion inhibitor contains m-toluic acid, and may optionally include sebacic acid.

The corrosion inhibitor may be utilized with any coolant composition. The coolant composition may be an antifreeze composition that includes a freezing point depressant. Exemplary coolant compositions include aqueous solutions containing alcohols. Common alcohols utilized in coolant compositions include ethanol, propanol, isopropanol, ethylene glycol, diethylene glycol. butanol, propylene glycol, and butylene glycol. The corrosion inhibitor may combined with any other appropriate coolant composition.

Other coolant additives may be used in conjunction with the corrosion inhibitor. Such additives may include dyes, antifoam agents, anticavitation agents, buffering agents, bittering agents, or any other additive commonly employed in coolant compositions. The additional coolant additives may include azoles, inorganic additives, aromatic organic acids, or aliphatic organic acids.

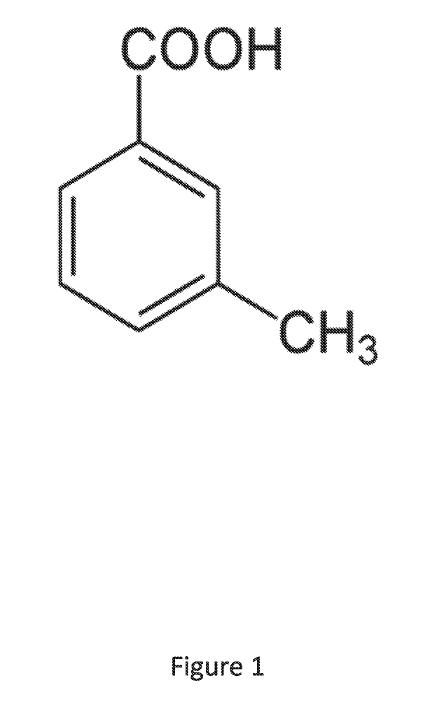

The corrosion inhibitor includes m-toluic acid. The molecular structure of m-toluic acid is shown in FIG. 1. The m-toluic acid may be present in the coolant composition in an amount of 0.05-10.0 wt. % based on the total weight of the coolant composition. The amount of the m-toluic acid may be at least 0.05 wt. % of the total weight of the coolant composition, such as at least 0.01 wt. %, 0.25 wt. %, 0.5 wt. %, 0.75 wt. %, 1.0 wt. %, 1.1 wt. %, 1.2 wt. %, 1.3 wt. %, 1.4 wt. %, 1.5 wt. %, or more. The amount of the m-toluic acid may be less than or equal to 10.0 wt. % if the coolant composition, such as less than or equal to 9.0 wt. %, 8.0 wt. %, 7.0 wt. %, 6.0 wt. %, 5.0 wt. %, 4.0 wt. %, 3.0 wt. %, 2.5 wt. %, 2.25 wt. %, 2.25 wt. %, 2.0 wt. %, 1.9 wt. %, 1.8 wt. %, 1.7 wt. %, or less.

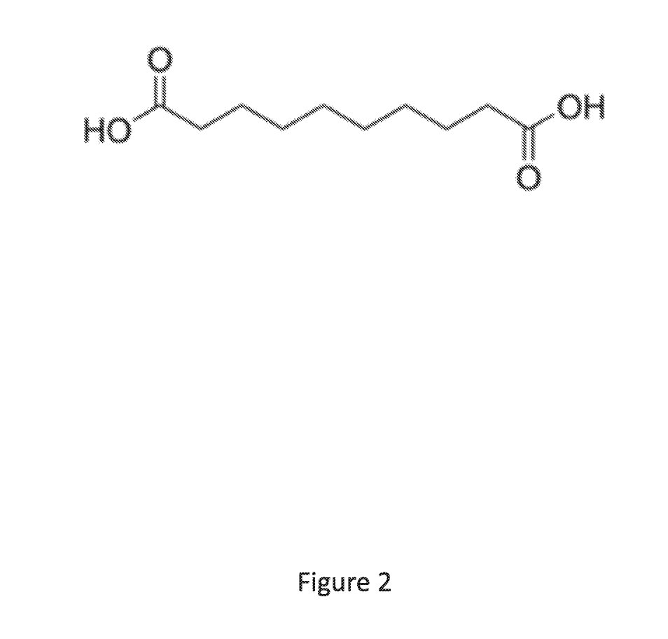

The corrosion inhibitor may optionally include sebacic acid. The molecular structure of sebacic acid is shown in FIG. 2. The sebacic acid may be present in the coolant composition in an amount of 0.05-10.0 wt. % based on the total weight of the coolant composition. The amount of the sebacic acid may be at least 0.05 wt. % of the total weight of the coolant composition, such as at least 0.1 wt. %, 0.25 wt. %, 0.5 wt. %, 0.75 wt. %, 1.0 wt. %, 1.25 wt. %, 1.5 wt. %, 1.75 wt. %, 2.0 wt. %, 2.1 wt. %, 2.2 wt. %, 2.3 wt. %, or more. The amount of the sebacic acid may be less than or equal to 10.0 wt. % if the coolant composition, such as less than or equal to 9.0 wt. %, 8.0 wt. %, 7.0 wt. %, 6.0 wt. %, 5.0 wt. %, 4.0 wt. %, 3.0 wt. %, 2.9 wt. %, 2.8 wt. %, 2.7 wt. %, 2.6 wt. %, 2.5 wt. %, or less.

The m-toluic acid and sebacic acid may have an affinity for metal surfaces in a cooling system, such as aluminum surfaces. In this manner, the m-toluic and sebacic acid inhibit corrosion of the aluminum in contact with the coolant composition. The corrosion inhibitor described herein provides more effective corrosion protection than other commonly employed organic acids at equivalent treat rates.

The corrosion inhibitor may additionally include additional components. The additional components may include tolytriazole (TT), benzatriazole (BT), nitrate, molybdate, or any other commonly employed corrosion inhibitor components. The additional components may be present in an amount of less than or equal to 5 wt. % of the total coolant composition, such as less than or equal to 4 wt. %, 3 wt. %, 2 wt. %, or 1.0 wt. % of the total coolant composition. For example, the additional components may be present in an amount of 0.005-5.0 wt. % of the total coolant composition. Individual additional components may be present in an amount of 0.005-5.0 wt. % of the total coolant composition.

The corrosion inhibitor may be free of silicates. Additionally, the coolant composition containing the corrosion inhibitor may be free of silicates.

An exemplary corrosion inhibitor may include m-toluic acid in an amount of 1.6 wt. %, sebacic acid in an amount of 2.4 wt. %, nitrate in an amount of 0.3 wt. %, molybdate in an amount of 0.1 wt. %, tolytriazole in an amount of 0.2 wt. %, and benzatriazole in an amount of 0.2 wt. %, where all amounts are relative to the total coolant composition. The composition of the exemplary corrosion inhibitor is shown in Table 1.

TABLE 1

| Component | Amount (wt. %) |
|---|---|
| m-toluic acid | 1.6 |
| Sebacic acid | 2.4 |
| Nitrate | 0.3 |
| Molybdate | 0.1 |
| Tolytriazole | 0.2 |
| Benzatriazole | 0.2 |

The corrosion inhibitor is compatible with all elastomers commonly employed in cooling systems, including silicone elastomers. The corrosion inhibitor is considered compatible with the elastomers because it does not attack or degrade the elastomers. The compatibility of the corrosion inhibitor with silicone elastomers allows the corrosion inhibitor to be utilized in cooling systems that include silicone seals.

The coolant composition including the corrosion inhibitor may be employed in any appropriate cooling system. For example, the coolant composition may be employed in a cooling system that cools an internal combustion engine. The cooling system may include aluminum components and silicone components that are exposed to the coolant.

The corrosion inhibitor was tested utilizing cavitation and corrosion testing to evaluate the aluminum protection capability of the current invention. Other corrosion inhibitors were also tested for comparison purposes.

The testing was conducted using the indirect method described in ASTM G32. Samples of cast aluminum, with uniform dimensions, were fixed to a sample holder at a distance of 0.5 mm below a ultrasonic horn operated at 20 kHz. The tip of the horn and the samples were placed in a 2,000 ml beaker and submerged in a test fluid. The beaker was immersed in a water bath to maintain a test temperature of 40° C. The test fluids were prepared by diluting the corrosion inhibitor compositions described in Table 2 with distilled water at a 30% treat rate.

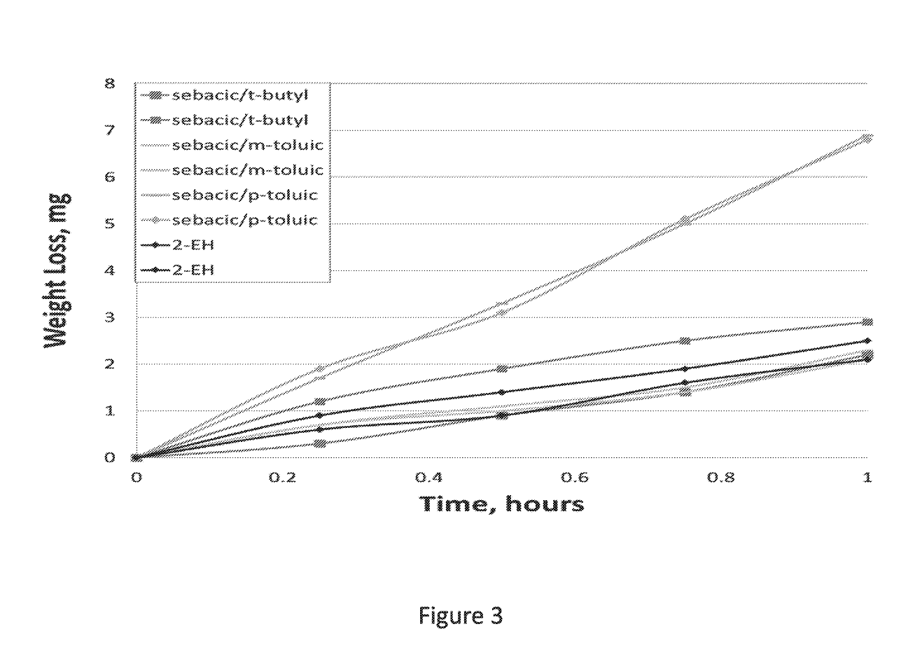

The aluminum samples were exposed to the cavitation inducing vibrations from the ultrasonic horn for one hour. Each sample was then removed from the test apparatus, dried, and weighed. The weight loss results are recorded in Table 2, and shown graphically in FIG. 3.

TABLE 2

| | Ex. 1 | C. Ex. 1 | C. Ex. 2 | C. Ex. 3 | C. Ex. 4 |
|---|---|---|---|---|---|
| m-toluic acid | 1.6 | 0 | 0 | 0 | 0 |
| p-toluic acid | 0 | 1.6 | 0 | 0 | 0 |
| Sebacic acid | 2.4 | 2.4 | 2.4 | 3.5 | 0.25 |
| t-butyl benzoic acid | 0 | 0 | 1.6 | 0 | 0 |
| Benzoic acid | 0 | 0 | 0 | 3.5 | 0 |
| 2-ethylhexanoic acid | 0 | 0 | 0 | 0 | 4 |
| Tolytriazole | 0.4 | 0.4 | 0.4 | 0.2 | 0.2 |
| Nitrate | 0.3 | 0.3 | 0.3 | 0.2 | 0 |
| Molybdate | 0.1 | 0.1 | 0.1 | 0.1 | 0 |
| Weightloss (mg) | 2.2 | 6.85 | 2.55 | 4.02 | 2.3 |

As shown in Table 2, Comparative Example 1 includes a mixture of sebacic acid and p-toluic acid, Comparative Example 2 includes a mixture of sebacic acid and t-butyl benzoic acid, Comparative Example 3 includes a mixture of sebacic acid and benzoic acid, and Comparative Example 4 includes a mixture of sebacic acid and 2-ethylhexanoic acid. The exemplary corrosion inhibitor includes a mixture of sebacic acid and m-toluic acid.

A corrosion inhibitor including a mixture of sebacic acid and o-toluic acid was also screened in glassware screening tests. The test results indicated that o-toluic acid was less effective than m-toluic acid or p-toluic acid.

As demonstrated by the experimental results of Table 2 and FIG. 3, the corrosion inhibitor of the current invention demonstrates improved aluminum cavitation and corrosion performance when compared to other corrosion inhibitors, such as the sebacic acid and p-toluic acid combination of Comparative Example 1. The composition of the current invention also demonstrated better performance when compared to combinations of sebacic acid with t-butyl benzoic acid and sebacic acid with benzoic acid, such as the mixtures of Comparative Examples 2 and 3, respectively. The composition of the current invention performed at least as well as the 2-Ethylhexanoic acid containing composition of Comparative Example 4, which is well established as an effective aluminum corrosion inhibitor.

Unlike antifreeze and coolant compositions based on 2-Ethylhexanoic acid combinations, the composition of the current invention is not aggressive toward silicone elastomer materials, such as those that may be used for gaskets and or hoses in cooling systems for internal combustion engines. Additionally, both sebacic acid and m-toluic acid are less hazardous than 2-Ethylhexanoic acid. For this reason, the corrosion inhibitor described herein is less hazardous than corrosion inhibitors that include 2-Ethylhexanoic acid.

In the foregoing description, it will be readily apparent to one skilled in the art that varying modifications may be made to the present disclosure without departing from the scope and spirit of the disclosure. The embodiments illustratively described herein suitably may be practiced in the absence of any element or elements, limitation or limitations, which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

1. A corrosion inhibitor for a coolant formulation, the corrosion inhibitor comprising m-toluic acid, wherein the corrosion inhibitor does not degrade elastomers.

2. The corrosion inhibitor of claim 1, wherein the m-toluic acid is present in an amount of 0.05-10.0 wt. % based on the total weight of the coolant formulation.

3. The corrosion inhibitor of claim 1, further comprising sebacic acid.

4. The corrosion inhibitor of claim 1, wherein sebacic acid is present in an amount of 0.05-10.0 wt. % based on the total weight of the coolant formulation.

5. The corrosion inhibitor of claim 1, wherein the corrosion inhibitor does not comprise silicates.

6. (canceled)

7. A method of increasing the corrosion resistance of a coolant formulation, comprising:
mixing a coolant formulation with m-toluic acid,
wherein the combination of the coolant formulation and the m-toluic acid does not degrade elastomers.

8. The method of claim 7, wherein the m-toluic acid is present in an amount of 0.05-10.0 wt. % based on the total weight of the coolant formulation.

9. The method of claim 7, further comprising mixing the coolant formulation with sebacic acid.

10. The method of claim 9, wherein the sebacic acid is present in an amount of 0.05-10.0 wt. % based on the total weight of the coolant formulation.

11. The method of claim 7, wherein the coolant formulation does not comprise silicates.

12. (canceled)

13. A coolant comprising:
a base fluid; and
a corrosion inhibitor comprising m-toluic acid,
wherein the corrosion inhibitor does not degrade elastomers.

14. The coolant of claim 13, wherein the base fluid is an antifreeze comprising a freezing point depressant.

15. The coolant of claim 13, wherein the base fluid is an aqueous solution containing an alcohol.

16. The coolant of claim 13, wherein the m-toluic acid is present in an amount of 0.05-10.0 wt. % based on the total weight of the coolant.

17. The coolant of claim 13, wherein the corrosion inhibitor further comprises sebacic acid.

18. The coolant of claim 17, wherein the sebacic acid is present in an amount of 0.05-10.0 wt. % based on the total weight of the coolant.

19. The coolant of claim 13, wherein the corrosion inhibitor does not comprise silicates.

20. (canceled)
